(19) United States
(12) Patent Application Publication
(10) Pub. No.: US 2020/0348794 A1
(43) Pub. Date: Nov. 5, 2020

(54) ULTRASOUND TOUCH DETECTION AND RELATED APPARATUSES AND METHODS

(71) Applicants: Tyler S. Ralston, Clinton, CT (US); Jianwei Liu, Fremont, CA (US); Jonathan M. Rothberg, Guilford, CT (US)

(72) Inventors: Tyler S. Ralston, Clinton, CT (US); Jianwei Liu, Fremont, CA (US); Jonathan M. Rothberg, Guilford, CT (US)

(73) Assignee: Butterfly Network, Inc., Guilford, CT (US)

(21) Appl. No.: 16/859,051

(22) Filed: Apr. 27, 2020

Related U.S. Application Data
(60) Provisional application No. 62/841,106, filed on Apr. 30, 2019.

(51) Int. Cl. G06F 3/043; G06F 3/041; G06F 3/0488

(52) U.S. Cl. CPC G06F 3/0436; G06F 3/0488; G06F 3/0412

(57) ABSTRACT

An electronic device with an ability to perform touch detection includes an ultrasound touch sensor disposed within a housing and configured to detect physical contact with an exterior surface of the housing. The sensor may emit ultrasonic sound waves, receive reflected ultrasonic sound waves reflected from a surface portion corresponding to the physical contact at the exterior surface of the housing, and compare the reflected ultrasonic sound waves to a stored reflection pattern. Based on determining a match between the reflected ultrasonic sound waves and the stored reflection pattern, the electronic device may activate a function. The sensor may be part of an ultrasound-on-a-chip device.

### CROSS-REFERENCE TO RELATED APPLICATION(S)

This application claims the benefit under 35 U.S.C. § 119(e) of U.S. Provisional Patent Application Ser. No. 62/841,106, filed Apr. 30, 2019, under Attorney Docket No. B1348.70122US00, and entitled “ULTRASOUND TOUCH DETECTION AND RELATED APPARATUSES AND METHODS,” which is hereby incorporated herein by reference in its entirety.

### FIELD OF THE DISCLOSURE

The present application relates generally to apparatuses and methods that use ultrasound sensors for touch detection, and more specifically to apparatuses and methods that use ultrasound sensors to detect smartphone activity or controller activity based on touch.

### BACKGROUND

Ultrasound systems may be used to perform diagnostic testing and imaging on an object, using acoustic or sound waves with frequencies that are higher than those audible to humans. Such testing and imaging may be performed non-destructively on the object. That is, the object need not undergo a physical transformation in order to be evaluated using ultrasonic sound waves. Sound waves classified as “ultrasonic” may have a frequency in a range of 0.1 MHz to 50 MHz.

Ultrasound imaging may be used to obtain images of internal body structures of living mammals. When sound waves are transmitted into such a body structure, at least some of the sound waves reflect off soft-tissue organs and other objects in the body structure. Different types of bodily material may reflect sound waves differently. The reflected sound waves may be transformed into an electrical signal, which may then be recorded and displayed as an ultrasound image. The strength or amplitude of the reflected sound waves, and the delay or time it takes for the sound waves to travel to and reflect from the organs and other objects of the body structure, provide information that may be used to produce the ultrasound image. Ultrasound imaging is commonly used for prenatal imaging, to obtain sonograms of a fetus in utero. Ultrasound imaging also is widely used for cardiology, where echocardiograms may be used to detect heart disease and heart damage and/or to visualize in vivo a heart's motion under stress, for example.

Ultrasound testing may be used to evaluate internal portions of solid structures. When sound waves are transmitted into a solid object, at least some of the sound waves reflect off the object's internal surfaces and interfaces. The strength or amplitude of reflected sound waves and the delay or time it takes for the sound waves to travel through the object and reflect or echo from the internal surfaces or interfaces provide information that may be used to determine whether the object's structural integrity is sound or whether a defect is present in the object. For example, ultrasound testing may be used to determine whether a hole or a crack is present in an object.

### SUMMARY OF THE DISCLOSURE

Ultrasound touch detection apparatuses and methods are described. In some aspects of the present technology, an ultrasound touch detection sensor includes an ultrasound-on-a-chip device having microfabricated ultrasonic transducers integrated with circuitry. The circuitry may be integrated circuitry of a complementary metal oxide semiconductor (CMOS) substrate. The ultrasound touch sensor may be part of an electronic device (e.g., smartphone, tablet computer, laptop computer, or other device) for which detecting a touch by a user is desired.

According to an aspect of the present technology, an electronic device able to perform ultrasonic touch detection includes an ultrasound touch sensor disposed within a housing. The sensor may be an ultrasound-on-a-chip device configured to detect physical contact with an exterior surface of the housing. The sensor may be configured to emit ultrasonic sound waves, receive reflected ultrasonic sound waves reflected from a surface portion corresponding to the physical contact at the exterior surface of the housing, and compare the reflected ultrasonic sound waves to a stored reflection pattern. Based on determining a match between the reflected ultrasonic sound waves and the stored reflection pattern, the electronic device may activate a function. For example, the electronic device may be a handheld remote controller for a home-entertainment system (e.g., a television controller, a sound system controller, etc.), a game controller for a computer game, a personal digital assistant (e.g., a smartphone, a tablet, etc.), and the like.

According to another aspect of the present technology, a smartphone device includes an ultrasonic transducer device, a memory device, and processing circuitry all located within a housing. The transducer device may be an ultrasound-on-a-chip device structured to transmit ultrasonic waves and to receive reflected waves of the ultrasonic waves. The processing circuitry may be operatively connected to the ultrasonic transducer device and the memory device, and may be programmed to perform a touch-detection routine to: control the ultrasonic transducer device to emit a ping ultrasonic wave; process reflection data obtained from the ultrasonic transducer, the reflection data corresponding to at least one reflected wave resulting from the ping ultrasonic wave; and activate a predetermined smartphone function if the reflection data is recognized to correspond to a pattern stored in the memory device.

The predetermined smartphone function may be one of: a user control function, an application functionality function, and an operating system function.

For example, the user control function may control any one or a combination of: speaker volume adjustment, microphone volume adjustment, screen brightness adjustment, camera operation, flashlight operation, wifi connectivity, and Bluetooth connectivity. As will be appreciated, other user controls may be controlled by the user control function.

For example, the application functionality function may control any one or a combination of: cursor movement, copy and paste operations, a page refresh operation, and a Web search operation. As will be appreciated, other types of application functionality may be controlled by the application functionality function.

For example, the operating system function may control any one or a combination of: application launch and exit operations, an application accessibility selection, software update operations, smartphone on and off operations, and user authentication operations. The application accessibility selection may enable any one or a combination of the following to be selected: speech input, keypad input, speech to text conversion, and text to speech conversion. As will be appreciated, other system features may be controlled by the operating system function.

The transducer device may include first and second ultrasonic transducers, such that the ping ultrasonic wave may include first and second ping waves emitted from the first and second ultrasonic transducers. The reflection data may correspond to a first reflected wave resulting from the first ping wave and a second reflected wave resulting from the second ping wave.

According to another aspect of the present technology, a smartphone device having a sleep mode and active mode may include: a housing having an interior and an exterior; a first array of ultrasonic transducers disposed in the interior of the housing; and processing circuitry disposed in the interior of the housing and configured to control the array of ultrasonic transducers to detect a touch on the exterior of the housing and to switch between the sleep mode and active mode in response to the touch. The smartphone device may also include a memory device disposed in the interior of the housing.

The processing circuitry may be programmed to, when the smartphone device is in the sleep mode, perform a touch-detection routine to: control the first array to emit a first ping of an ultrasonic wave; process first reflection data output from the first array, the first reflection data corresponding to a first reflected wave resulting from the first ping; and activate the active mode if the first reflection data is recognized to correspond to a wake-up touch based on data stored in the memory device.

According to another aspect of the present technology, a method of detecting a touch on an electronic device may include: emitting, from an ultrasound touch sensor disposed within a housing of the electronic device, a ping of ultrasonic sound waves; receiving by the ultrasound touch sensor, reflected ultrasonic sound waves reflected from a surface portion corresponding to a physical contact on an exterior surface of the housing; and comparing, by processing circuitry of the electronic device, data corresponding to the reflected ultrasonic sound waves to a stored reflection pattern. The method also may include activating a function of the electronic device when a match is determined between the data corresponding to the reflected ultrasonic sound waves and the stored reflection pattern.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference numeral in all the figures in which they appear.

FIG. 1A shows a user's hand holding a television remote controller that may be equipped with an ultrasound touch sensor, according to a non-limiting embodiment of the present technology.

FIG. 1B shows a user's hands holding a game controller that may be equipped with an ultrasound touch sensor, according to a non-limiting embodiment of the present technology.

FIG. 1C schematically illustrates a perspective view of a smartphone equipped with an ultrasound touch sensor, according to a non-limiting embodiment of the present technology.

FIG. 1D schematically illustrates top and bottom plan views of a smartphone.

FIG. 1E shows an example of a smartphone in an exploded view.

FIGS. 2A-2H show various ways in which a smartphone may be held by a user's hand(s).

FIG. 3 is a block diagram of an ultrasound touch sensor, according to a non-limiting embodiment of the present technology.

FIG. 4 is a block diagram illustrating a non-limiting example of communication of signals between various components of the ultrasound touch sensor, according to a non-limiting embodiment of the present application.

FIG. 5 schematically illustrates an internal portion of a smartphone, according to a non-limiting embodiment of the present technology.

FIG. 6 schematically illustrates a smartphone and a removable case, according to a non-limiting embodiment of the present technology.

### DETAILED DESCRIPTION

Exterior surface characteristics of a solid object may be evaluated using ultrasonic sound waves. When sound waves are launched or transmitted within a solid object, at least some of the sound waves may reflect off the object's outer or exterior surfaces. (The terms “external” and “exterior” may be used interchangeably herein. The terms “internal” and “interior” may be used interchangeably herein.) The strength or amplitude of the sound waves reflected from one or more of the exterior surfaces, and the delay or time it takes for the sound waves to travel to and reflect or echo from the exterior surface(s), may be used to obtain information about the object's exterior surface(s), such as whether an exterior surface of the object is being touched.

Ultrasonic sound waves may be produced using a transducer (ultrasonic transducer) manufactured using known microfabrication techniques. For example, the ultrasonic transducer may include a flexible membrane suspended above a cavity in a substrate, forming a variable capacitor. When actuated by an appropriate electrical signal, the membrane may generate ultrasonic sound waves by vibration. These sound waves may be launched into or on an object to be imaged and/or tested, and reflected sound waves may cause the membrane of the ultrasonic transducer (or a membrane of a different ultrasonic transducer) to vibrate. The vibrations may be transformed into an electrical signal for imaging or further testing.

When a user touches an exterior surface of the object, one or more of the object's physical properties at the touched portion may undergo a change. For example, the touched portion may undergo a temperature change caused by heat from a finger, and/or the touched portion may undergo a change in surface strain caused by a touch-induced surface pressure. Such changes may cause the acoustic reflection characteristics of the object to change at the touched portion, which in turn may cause ultrasonic sound waves traveling within the object to have different reflection or echo characteristics when the object is being held in a user's hand(s) in comparison with when the object is resting on a table surface or in a jacket pocket, for example.

The acoustic reflection characteristics of the object may be used to determine whether the user is grasping the object for a particular purpose, or whether the object is being incidentally touched for no particular purpose. For example, the object may be a remote controller for a game system. Pulses of ultrasonic sound waves launched within the remote controller may give rise to an echo or acoustic reflection pattern corresponding to sound waves that reflect off the remote controller's outer or exterior surfaces. When the acoustic reflection pattern of the remote controller does not substantially change for a predetermined amount of time, it may be determined that the game system is not being used and therefore the game system may enter (or remain in) a dormant mode. When the acoustic reflection pattern of the remote controller changes to a new acoustic reflection pattern, it may be determined that the remote controller is being grasped for use and therefore the game system may enter an active mode where other electronic circuitry of the game system may be energized for use. Alternatively, when the acoustic reflection pattern of the remote controller changes to a new acoustic reflection pattern, the game system may enter the active mode only if the new acoustic reflection pattern is determined to be substantially similar to a pattern stored in a memory of the game system.

In another example, the object may be a personal digital assistant (PDA), such as a smartphone, or a tablet computer, or the like. Pulses of ultrasonic sound waves launched within the PDA may give rise to an echo or acoustic reflection pattern corresponding to sound waves that reflect off the PDA's outer or exterior surfaces. When the acoustic reflection pattern of the PDA is substantially unchanged for a predetermined amount of time, it may be determined that the PDA is not being used and therefore the PDA may enter (or remain in) a dormant or sleep mode. When the acoustic reflection pattern of the PDA changes to a new acoustic reflection pattern, it may be determined that the PDA is being touched for further use and therefore the PDA may enter an active mode where a function of the PDA is activated for use, such as a user-authentication function. Alternatively, when the acoustic reflection pattern of the PDA changes to a new acoustic reflection pattern, the PDA may enter the active mode only if the new acoustic reflection pattern is determined to be substantially similar to a pattern stored in a memory of the PDA.

Aspects of the present application provide an ultrasound touch sensor. The ultrasound touch sensor may utilize capacitive ultrasound sensing technology in the form of, for example, one or more capacitive ultrasonic transducers. The ultrasound touch sensor may be an ultrasound-on-a-chip device incorporated into various mobile electronic equipment, such as smartphones, tablet computers, remote controllers, and the like.

According to an aspect of the present technology, an electronic apparatus includes an ultrasound touch sensor disposed within a housing of the apparatus. The ultrasound touch sensor is configured to sense a user's touch or physical contact on the apparatus, such as when the user picks up the apparatus in order to use the apparatus. The apparatus may have a dormant or sleep mode and an active mode. In the dormant mode, the apparatus is not in use. The apparatus may enter the dormant mode when the apparatus is determined to have been inactive for a predetermined minimum period of time, in order to conserve energy usage. In order to enter the active mode, the apparatus may require “waking up” or activation before various functions of the apparatus may be used. The waking up or activation may require a user to touch or grasp the apparatus.

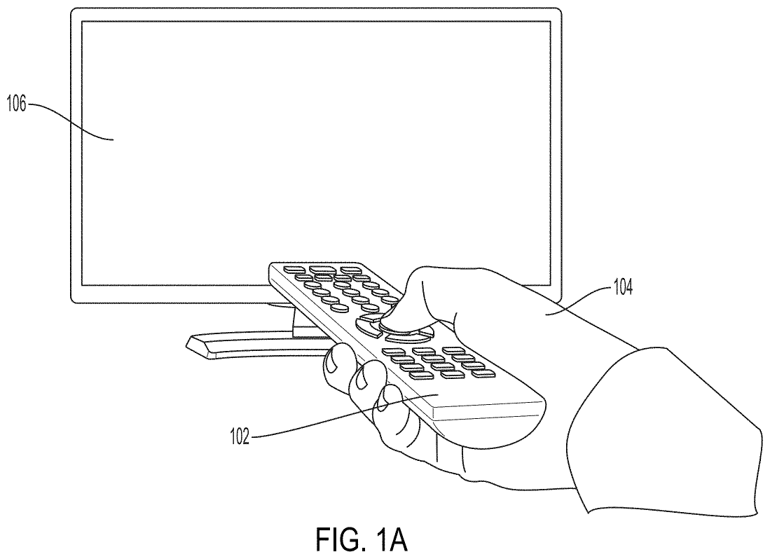

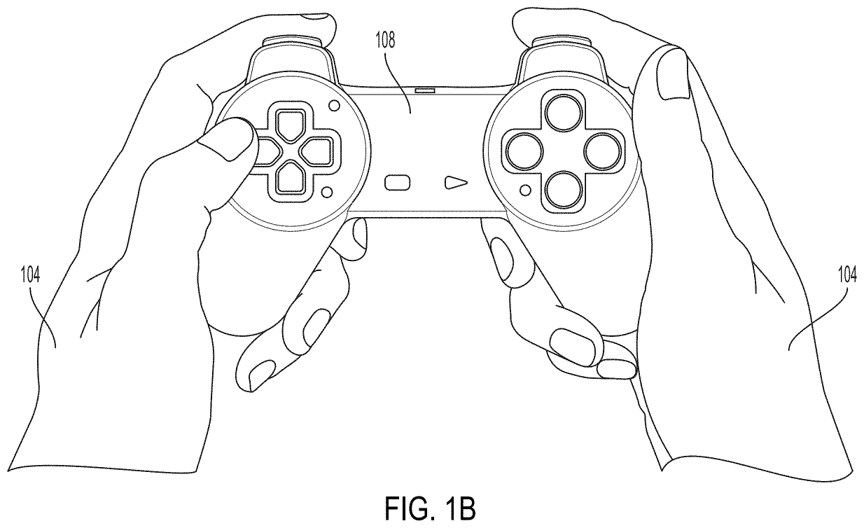

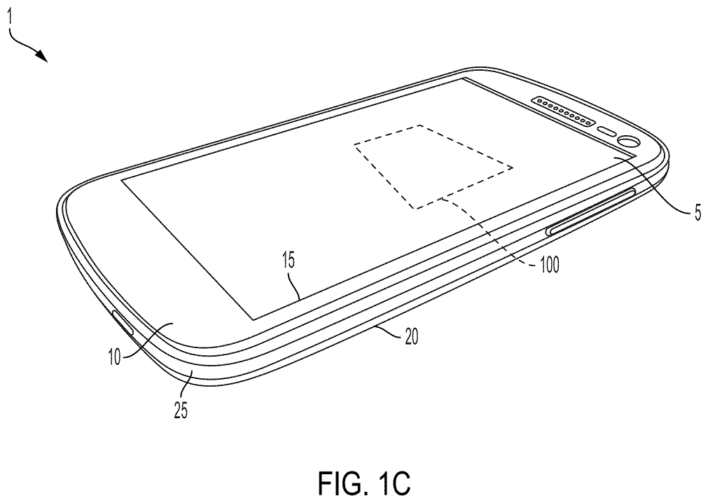

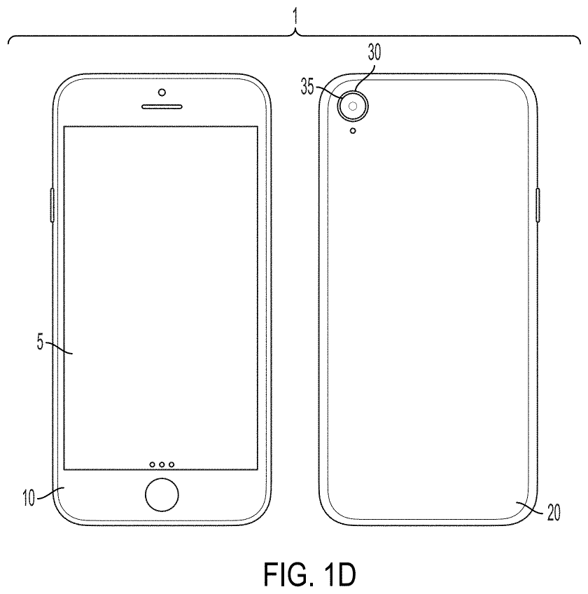

For example, the electronic device may be a handheld remote controller for a home-entertainment system (e.g., a television controller, a sound system controller, etc.), a game controller for a computer game, a personal digital assistant (e.g., a smartphone, a table, etc.), and the like, which may be equipped with the ultrasound touch sensor. FIG. 1A shows a television remote controller 102 in a user's hand 104 for controlling a television 106, and FIG. 1B shows a game controller 108 in a user's hands 104.

According to another aspect of the present technology, an ultrasound touch sensor is disposed within a housing of an electronic device. The ultrasound touch sensor is configured to detect physical contact on an outer or exterior surface of the housing, such as a user's touch or grasp on the exterior surface. For example, the contact may be on an exterior edge surface of the housing. The ultrasound touch sensor may be configured to emit ultrasonic sound waves within the housing, and to receive reflected sound waves reflected from exterior surfaces of the housing. The ultrasound touch sensor may be an ultrasound-on-a-chip device and may include processing circuitry configured to compare an acoustic reflection pattern of the reflected sound waves to one or more patterns stored in a memory device housed in the housing of the electronic device. The processing circuitry may be integrated on the same chip as the ultrasound touch sensor. For example, one or more ultrasonic transducers of the ultrasound touch sensor, and electronic circuitry used to perform collection and processing of ultrasound signals and/or data, may be integrated on a single chip. Alternatively, the electronic device may include processing circuitry disposed in the housing separately from the ultrasound touch sensor, but in communication with the ultrasound touch sensor, to compare the acoustic reflection pattern of the reflected sound waves to the one or more patterns stored in the memory. If the processing circuitry determines that there is a match between the acoustic reflection pattern of the reflected sound waves and a pattern stored in the memory, the processing circuitry may activate a function of the electronic device.

The processing circuitry may control the ultrasound touch sensor to check a current acoustic reflection pattern of the electronic device on a periodic basis, to determine whether the electronic device: (i) is to remain in a dormant state, or (ii) is to be placed in the dormant state, or (iii) is to be place in an active state because the electronic device is being touched or grasped for use. If it is determined that the electronic device is being touched or grasped for use, the processing circuitry may notify a controller of the electronic device. The controller may, in turn, activate a predetermined function of the electronic device.

The processing circuitry may be a programmed microprocessor or may be formed of a discrete ASIC (Application-Specific Integrated Circuit) logic circuit. The controller may be formed of a discrete ASIC control circuit or may be a programmed microprocessor. A single programmed microprocessor may be used for the processing circuitry and the controller.

According to another aspect of the present technology, an ultrasonic touch sensor includes a housing, a transducer device located within the housing, a memory device located within the housing, and processing circuitry located within the housing. The transducer device is structured to transmit ultrasonic sound waves within the housing and to receive sound waves reflected from external surfaces of the housing. The processing circuitry is operatively connected to the transducer device and the memory device, and is configured to: control the transducer device to emit a ping or pulse of ultrasonic waves, process reflection data obtained from the transducer device, and activate a predetermined function if the reflection data is recognized to correspond to a pattern stored in the memory device. The reflection data may be an acoustic reflection pattern corresponding to reflected or echo sound waves resulting from the ping or pulse of ultrasonic sound waves.

According to another aspect of the present technology, a smartphone device is structured to include: a housing, an ultrasonic transducer device located within the housing, a memory device located within the housing, and processing circuitry located within the housing. The transducer device is structured to transmit ultrasonic sound waves within the housing and to receive reflected waves of the ultrasonic sound waves. The processing circuitry is operatively connected to the ultrasonic transducer device and the memory device, and is structured to perform a touch-detection routine to: control the ultrasonic transducer device to emit a ping or pulse of ultrasonic sound waves; process reflection data obtained from the transducer device, and activate a predetermined smartphone function if the reflection data is recognized to correspond to a pattern stored in the memory device. The reflection data may be an acoustic reflection pattern corresponding to reflected or echo waves resulting from the ping or pulse of ultrasonic sound waves. The processing circuitry may be an ASIC or may be part of a microprocessor of the smartphone device.

The predetermined smartphone function may be one of: a user control function, an application functionality function, and an operating system function.

The user control function may enable a user to adjust a volume of audio output from a speaker and/or audio input to a microphone. The user control function also may enable a user to adjust a brightness of an image or a video on a display screen, to operate a camera and/or a flashlight operation, and to activate a wifi connection or a Bluetooth connection. As will be appreciated, other user controllable smartphone features may be controlled by the user control function.

The application functionality function may enable a user to move a cursor to, for example, scroll or navigate an image displaying on the smartphone. This function also may enable a user to perform copy and paste operations, refresh information on a display screen, and perform a Web search operation. Additionally, this function may enable to make a selection from a user interface displaying on a display screen of the smartphone. As will be appreciated, other types of functionality of a smartphone may be controlled by the application functionality function.

The operating system function may enable a user to launch a smartphone application as well as exit from a smartphone application. The operating system function also may enable the smartphone to be turned on and off, to update software, and to perform a user authentication procedure to verify that the user is authorized to use the smartphone. The operating system function may further enable a user to select an application accessibility option, such as speech input, keypad input, speech to text conversion, and text to speech conversion. As will be appreciated, other types of system functionality of a smartphone may be controlled by the operating system function.

The ultrasonic transducer device may include first and second ultrasound transducers. The ping or pulse of ultrasonic sound waves may include first and second ping waves emitted from the first and second ultrasound transducers. The reflection data may include an acoustic reflection pattern corresponding to first reflected waves and second reflected waves, in which the first reflected waves result from the first ping waves, and in which the second reflected waves result from the second ping waves. As will be appreciated, subsequent reflection patterns corresponding to subsequent reflected waves resulting from third ping waves, fourth ping waves, etc., may be included in the reflection data. This way, hand movement on the smartphone device may be detected. For example, sequential changes in the reflection patterns may indicate a swiping motion on the surface of the smartphone device by the user.

Different sequential changes in the reflection pattern may correspond to different swiping motions. For example, a sequence may indicate a swipe motion toward a predetermined location on the smartphone. A differentiation between swiping by one finger or swiping by a plurality of fingers may be possible by analysis of sequential reflection patterns. The swiping motion may be a pinch-to-corner motion, a top-to-bottom motion, a bottom-to-top motion, a left-to-right motion, and a right-to-left motion.

Alternatively, different sequential changes in the reflection pattern may be indicative of a holding position in combination with a movement, with the holding position corresponding to the user grasping the smartphone in a preferred position, and with the movement corresponding to a swiping motion of at least one finger toward a predetermined location on the smartphone or corresponding to a tapping motion at a predetermined location on the smartphone. For example, the predetermined location of the tapping motion may be comprised of a first predetermined tapping location of a first finger and a second predetermined tapping location of a second finger. In another example, the holding position may correspond to the user touching each of four edges of the smartphone. In another example, the holding position may be the user grasping the smartphone such that a palm of the user touches an edge of the smartphone.

As will be appreciated, the different swiping motions and the different holding positions, when recognized from their reflection patterns, may be used to cause different effects in the smartphone device.

According to another aspect of the present technology, a smartphone device having a sleep mode and an active mode is provided. The smartphone may include a housing, an ultrasound touch sensor device disposed in an interior of the housing, and processing circuitry disposed in the interior of the housing. The processing circuitry may be configured to control a first transducer array of the ultrasound touch device to detect a touch on an exterior surface of the housing. In response to the touch, the processing circuitry may switch between the sleep mode and the active mode. The first transducer array may include at least one ultrasound transducer.

The processing circuitry may be operatively connected to a memory device disposed in the interior of the housing. The processing circuitry may be programmed to perform a touch-detection routine in which, when the smartphone device is in the sleep mode, the touch-detection routine may: control the first transducer array to emit a first ping or pulse of ultrasonic sound waves, process first reflection data output from the first transducer array, and activate the active mode if the first reflection data is recognized to correspond to a wake-up touch based on data stored in the memory device. The first reflection data may be an acoustic reflection pattern corresponding to first reflected waves resulting from the first ping or pulse.

The touch-detection routine may analyze the first reflection data to determine whether an acoustic impedance of the first reflected waves has changed. If the acoustic impedance of the first reflected waves has changed and if the change is above a first predetermined value, the touch-detection routine may determine that a first touch has occurred, causing an anomaly in the first reflected waves. The touch-detection routine also may determine a location of the first touch on the exterior surface of the housing based at least in part on a time delay between emission of the first ping or pulse and receipt of the first reflected waves corresponding to the first touch.

The ultrasound touch device may include a second transducer array. The second transducer array may include at least one ultrasound transducer. The touch-detection routine may: control the second transducer array to transmit a second ping or pulse of ultrasonic sound waves different from the first ping or pulse, and process second reflection data output from the second transducer array. The second reflection data may be an acoustic reflection pattern corresponding to second reflected waves resulting from the second ping or pulse. The touch-detection routine may analyze the second reflection data to determine whether an acoustic impedance of the second reflected waves has changed. If the acoustic impedance of the second reflected waves has changed and if the change is above a second predetermined value, the touch detection-routine may determine that a second touch has occurred, causing an anomaly in the second reflected waves. The touch-detection routine also may determine a location of the second touch on the exterior surface of the housing based at least in part on a time delay between emission of the second ping or pulse and receipt of the second reflected waves corresponding to the second touch.

The first transducer array may include one ultrasonic transducer or multiple ultrasonic transducers. If the first transducer array includes multiple ultrasonic transducers, the touch-detection routine may control the multiple ultrasonic transducers to emit the first ping or pulse in unison or sequentially.

Similarly, the second transducer array may include one ultrasonic transducer or multiple ultrasonic transducers. If the second transducer array includes multiple ultrasonic transducers, the touch-detection routine may control the multiple ultrasonic transducers to emit the second ping or pulse in unison or sequentially.

The first and second transducer arrays may be disposed adjacent each other within the housing or may be spaced apart from each other by a predetermined distance within the housing.

The touch-detection routine may determine whether the location of the first touch and the location of the second touch are at different positions on the exterior surface of the housing or at a same position on the exterior surface of the housing, based on the first and second reflected waves.

If the locations of the first and second touches are at different positions on the exterior surface of the housing, the touch-detection routine may determine whether the first and second touches are on opposite edge portions of the exterior surface of the housing. The touch-detection routine may determine a multiple-touch event for the wake-up touch when the location of the first touch is different from the location of the second touch.

If the locations of the first and second touches are at the same position on the exterior surface of the housing, the touch-detection routine may determine a single-touch event for the wake-up touch, in which the location of the first touch corresponds to the location of the second touch. That is, a single touch may give rise to the first reflection data corresponding to the first reflected waves resulting from the first ping or pulse and also to the second reflection data corresponding to the second reflected waves resulting from the second ping or pulse.

The touch-detection routine may distinguish between a palm touch and a finger touch based on differences in their reflection patterns.

The processing circuitry may determine that a wake-up touch has occurred based on the location of the first touch, or the location of the second touch, or a combination of the locations of the first and second touches.

When the processing circuitry determines that a wake-up touch has occurred, the processing circuitry may cause a predetermined smartphone function to commence. For example, the processing circuitry may issue a wake-up signal to a controller of the smartphone to cause the controller to execute or run the predetermined smartphone function. The predetermined smartphone function may be a user authentication function, which may be any one or a combination of: a fingerprint recognition function, a retina recognition function, a face recognition function, and a user-input recognition function. For example, the user authentication function may compare authentication data stored in the memory device with any one or a combination of: a fingerprint image input, a retinal image input, a facial image input, and an alphanumeric input.

If the touch-detection routine determines that the first reflection data does not to correspond to any of a plurality of wake-up patterns stored in the memory device, the touch-detection routine may cause the smartphone device to remain in the sleep mode or to enter the sleep mode. For example, the processing circuitry may issue a sleep signal to the controller of the smartphone to cause the controller to execute or run a sleep routine, or the processing circuitry may issue no wake-up signal to the controller to cause the smartphone device to remain in the sleep mode.

The touch-detection routine may: control the first transducer array to emit a series of pings or pulses of ultrasonic sound waves, and process a series of reflection data output from the first transducer array. The series of reflection data may be a series of acoustic reflection patterns corresponding to reflected waves resulting from the series of ping or pulses. If the processing circuitry determines that the series of acoustic reflection patterns are substantially the same, the processing circuitry may determine that the smartphone device is not being used and therefore may issue a sleep signal to the controller to cause the controller to execute or run the sleep routine.

The interior of the housing may be delimited by top and bottom cover portions and an edge cover portion. The top and bottom cover portions may form first and second major surfaces of the housing, and may be substantially planar. The edge cover portion may be positioned adjacent outer peripheries of the top and bottom cover portions such that the edge cover portion may separate the top cover portion from the bottom cover portion.

The first transducer array may be arranged in the housing such that a major surface of the first transducer array may be parallel to a first edge surface of the edge cover portion of the housing. The first transducer array may be structured to emit ultrasonic sound waves to a first launch region of housing material forming the first edge surface. The housing material forming the first edge surface may be part of a transmission path within the housing.

More specifically, the housing may include a transmission path on which ultrasonic sound waves may travel. The transmission path may be connected to the first transducer array via an ultrasound coupling medium, which is a medium that may provide impedance matching and therefore reduce undesired reflections of the ultrasonic sound waves. The ultrasound coupling medium may be formed of a solid material. For example, the solid material may be an elastomer. The transmission path may be visibly distinguishable from the housing or may be integral with and visibly indistinguishable from the housing. The transmission path may include a portion disposed on the exterior surface of the housing. For example, the transmission path may include a portion disposed on the edge cover portion of the housing. The first edge surface may be part of the edge cover portion of the housing.

If the ultrasound touch sensor includes a second transducer array, the second transducer array may be arranged in the housing such that a major surface of the second transducer array may be parallel to a surface other than the first edge surface, such as, for example, a second edge surface of the housing different from the first edge surface. For instance, the second edge surface may be situated on a side of the housing opposite to the first edge surface. The second transducer array may be structured to emit ultrasonic sound waves to a second launch region of housing material forming the second edge surface. The housing material forming the second edge surface may be part of the same transmission path as the housing material forming the first edge surface, or may be part of a different transmission path of the ultrasonic sound waves within the housing.

The housing may be structured to receive a removable external cover thereon. The transmission path may include a connector portion structured to connect with a transmission path on the removable external cover. Alternatively, the removable external cover may include at least one cutout to enable a user to touch at least one portion of the transmission path of the housing.

Optionally, the touch-detection routine may be disabled when at least one predetermined function of the smartphone device is in use. For example, if an audio player function of the smartphone device is in use, the touch-detection routine may be disabled to prevent the smartphone device from entering the sleep mode. Therefore, if the smartphone device has a predetermined minimum period of non-use before the sleep mode is automatically entered, the smartphone device may remain in the active mode and not enter the sleep mode after the predetermined minimum period has occurred, if any one of a group of predetermined functions is in use.

The memory device may store one or more patterns. The patterns may be user-specific patterns corresponding to a single user or to a predetermined user group of at least one user. Alternatively, the patterns may be general patterns not specific to any particular user.

The processing circuitry may be configured to perform a training routine to enable touch data to be inputted actively or passively by a user, and to store the touch data as a pattern in the memory device. The touch data may correspond to a holding position, and may be inputted passively by the user by, for example, grasping the smartphone in a particular position for a predetermined number of times to, e.g., make a call, with each time giving rise to a common acoustic reflection pattern; in such a case, the acoustic reflection pattern may be stored automatically in the memory device. Optionally, the training routine of the processing circuitry may enable a plurality of touch data to be inputted actively by the user, and may store the inputted touch data as patterns in the memory device. Alternatively, the processing circuitry may be programmed to perform a training routine to enable touch data to be inputted by a plurality of users, and to store the touch data as patterns in the memory device. The patterns may be correspondingly associated with the plurality of users in the memory device.

Alternatively, in addition to or instead of the user-specific patterns discussed above (e.g., the grasping patterns, the movement or swiping patterns, etc.), the memory device may store wake-up patterns corresponding to common hand positions for holding a smartphone device for use and/or common movement or swiping patterns on a smartphone device.

Optionally, the processing circuitry may be configured to perform a second touch-detection routine when the smartphone device is in the active mode. The second touch-detection routine may: control the ultrasonic touch sensor to emit an active-mode ping or pulse of ultrasonic sound waves, process active-mode reflection data obtained by the ultrasonic touch sensor, and compare the active-mode reflection data with the active-mode patterns stored in the memory device. The active-mode reflection data corresponds to at least one wave reflected from the active-mode ping or pulse. If the active-mode reflection data is determined to correspond to an active-mode pattern stored in the memory device, the processing circuitry may cause the controller to activate any one or a combination of: a volume adjustment function, a brightness adjustment function, a cursor movement function, an application launch function, an item selection function, as well as the various functionalities of the user control function, the application functionality function, and the operating system function discussed above.

For example, the active-mode reflection data may match an active-mode pattern for a volume-adjustment touch, in which case the controller may cause a volume-adjustment interface to appear on the display screen of the smartphone device. In another example, the active-mode reflection data may match an active-mode pattern for a messaging function, in which case the controller may cause a message application to launch and a messaging interface to appear on the display screen of the smartphone device.

The discussions below may describe embodiments in which an ultrasound touch sensor according to the present application is incorporated in a smartphone. However, the ultrasound touch sensor is not limited to use in a smartphone but may be incorporated in other electronic apparatuses, including but not limited to those mentioned above.

FIG. 1C schematically illustrates a perspective view of a smartphone 1 equipped with an ultrasound touch sensor 100. The smartphone 1 may include a display screen 5, an upper cover 10 having an opening 15 through which the display screen 5 is exposed, a lower cover 20 oriented substantially parallel to the display screen 5 and the upper cover 10, and an edge portion 25 separating the upper cover 10 from the lower cover 20. The display screen 5 may be a pressure-sensitive touchscreen, which enables information to be inputted by tapping.

FIG. 1D schematically illustrates a plan view of the display screen 5 and the upper cover 10 of the smartphone 1 (left side of figure), and a plan view of the lower cover 20 of the smartphone 1 (right side of figure). The lower cover 20 may include an opening 30 through which a camera 35 is exposed. As will be appreciated, the smartphone 1 shown in the drawings may have various configurations, in which buttons, cameras, switches, microphones, etc., may be located at various different positions in the various configurations.

Although FIG. 1C shows the upper cover 10 and the display screen 5 to be separate units, it should be appreciated that a display screen and an upper cover may be formed integrally as a single display/cover unit 5a, as shown in the exploded view of FIG. 1E, in which various internal and external components of a smartphone 1a are depicted.

A smartphone is a mobile electronic apparatus that typically is held by a hand (or two hands) of a user when the user is making a call, inputting a text message, playing a game, taking a picture, etc. When the user is making a call, the smartphone may be grasped by one hand at any of a plurality of different hand positions. When the user is inputting a text message, the smartphone may be grasped by one hand or by two hands at any of a plurality of different hand positions. When the user is taking a picture, the smartphone may be grasped by one hand or by two hands at any of a plurality of different hand positions.

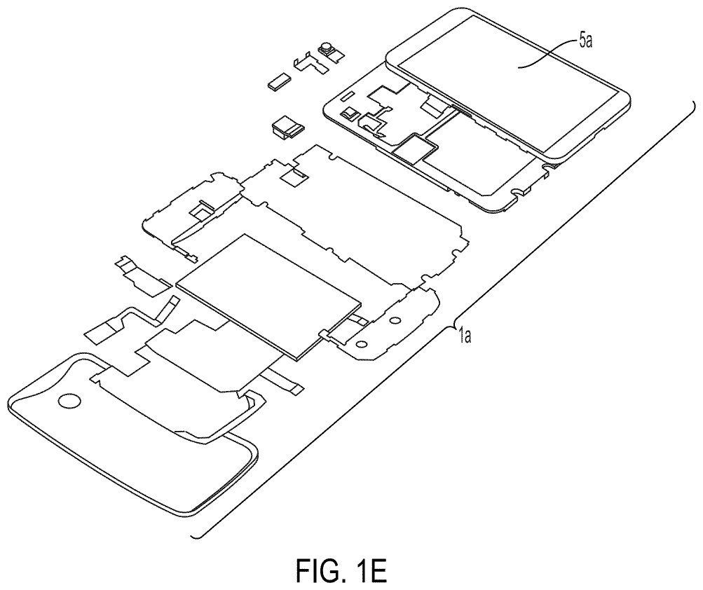

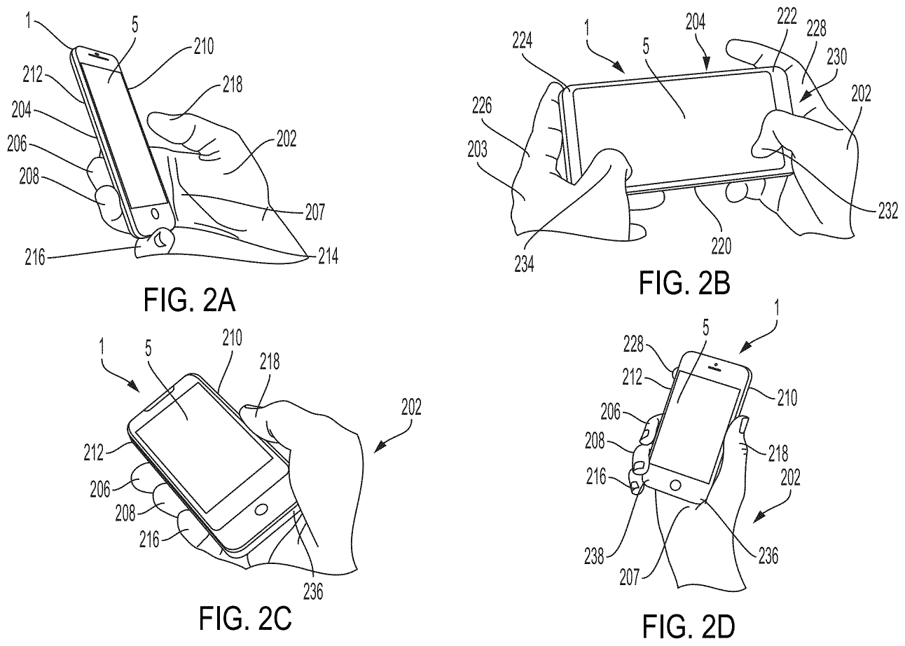

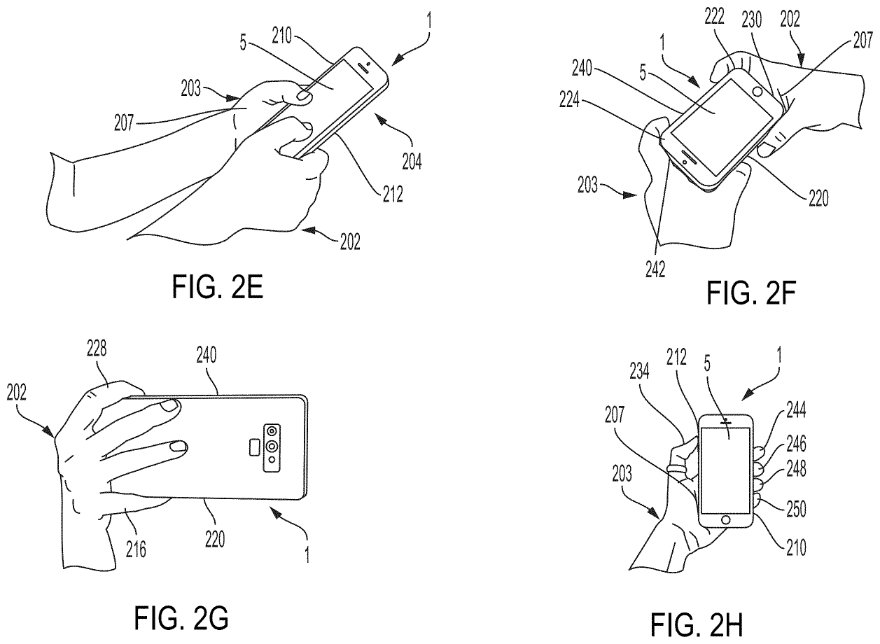

FIGS. 2A-2H show examples of various ways a smartphone may be held by one hand or two hands.

In FIG. 2A, the user holds a smartphone 1 in a portrait or vertical orientation with one hand, the right hand 202. The back 204 of the smartphone 1 rests against the middle and fourth fingers 206 and 208. The right long edge 210 of the smartphone (“right” being relative to the display screen) is in contact with part of the user's palm 207, and the left long edge 212 is in contact with the middle finger 206 and/or the fourth finger 208. The lower short edge 214 of the smartphone rests against the pinky finger 216, and the thumb 218 may be used to tap on the smartphone's display screen 5.

In FIG. 2B, the user holds a smartphone 1 in a landscape or horizontal orientation with two hands 202 and 203, such that the lower long edge 220 of the smartphone 1 rests against a finger of each hand. The upper corners 222 and 224 of the smartphone rest against the two index fingers 226 and 228, and the right short edge 230 is in contact with a part of the right index finger 228. The thumbs 232 and 234 may be used to tap on the smartphone's display screen 5.

In FIG. 2C, the user holds a smartphone 1 in a portrait or vertical orientation with one hand, the right hand 202. The left long edge 212 of the smartphone is in contact with the middle 206, fourth 208, and pinky fingers 216, and the right long edge 210 is in contact with the thumb 218. The lower right corner 236 of the smartphone is in contact with part of the user's palm. A finger of the user's left hand (not shown) may be used to tap on the smartphone's display screen 5.

In FIG. 2D, the user holds a smartphone 1 in a portrait or vertical orientation with one hand, the right hand 202. The left long edge 212 of the smartphone is in contact with the index 228, middle 206, and fourth 208 fingers, and the right long edge 210 is in contact with the thumb 218. The lower right corner 236 of the smartphone is in contact with part of the user's palm 207, and the lower left corner 238 is in contact with the pinky finger 216. A finger of the user's left hand (not shown) may be used to tap on the smartphone's display screen 5.

In FIG. 2E, the user holds a smartphone 1 in a portrait or vertical orientation with two hands 202 and 203, such that the back 204 of the smartphone rests against fingers from each hand. The right and left long edges 210 and 212 of the smartphone are in contact with parts of the user's palm 207. The thumbs may be used to tap on the smartphone's display screen 5.

In FIG. 2F, the user holds a smartphone 1 in a landscape or horizontal orientation with two hands 202 and 203, such that the lower long edge 220 of the smartphone rests against the thumbs of each hand. The upper right and left corners 222 and 224 of the smartphone, and parts of the upper long edge 240 adjacent these corners, are in contact with sections of the user's index fingers. Parts of the right and left short edges 230 and 242 adjacent the upper right and left corners 222 and 224 of the smartphone are in contact with other sections of the user's index fingers and with parts of the user's palm 207. The upper corners 222 and 224 of the smartphone rest against the two index fingers, and the right short edge 230 is in contact with a section of the right index finger. One of the thumbs may be used to tap on the smartphone's display screen 5.

In FIG. 2G, the user holds a smartphone 1 in a landscape or horizontal orientation with one hand, the right hand 202, such that the lower long edge 220 of the smartphone rests against the user's pinky 216. The lower left corner of the smartphone is in contact with part of the user's palm. The upper left corner of the smartphone, and a portion of the upper long edge adjacent this corner, is in contact with the user's index finger 228. The thumb and/or a finger of the user's left hand may be used to tap on the smartphone's display screen (facing into the page).

In FIG. 2H, the user holds a smartphone 1 in a portrait or vertical orientation with one hand, the left hand 203. The left long edge 212 of the smartphone is in contact with the thumb 234 and part of the user's palm 207, and the right long edge 210 is in contact with the index 244, middle 246, fourth 248, and pinky 250 fingers. A finger of the user's right hand may be used to tap on the smartphone's display screen 5.

As can be appreciated from the examples shown in FIGS. 2A-2H, a smartphone can be touched or grasped in different ways by a user, with each way potentially resulting in a distinct reflection pattern.

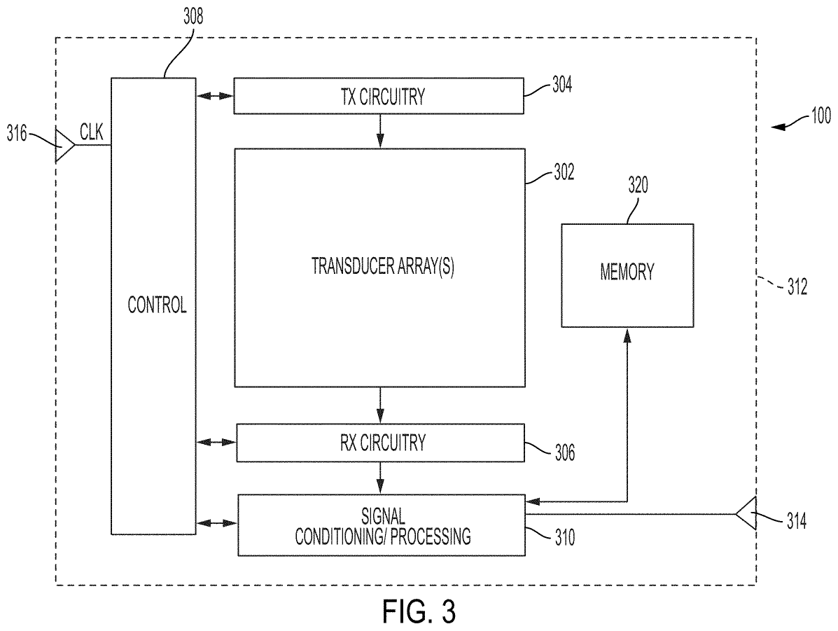

FIG. 3 schematically illustrates an example of the ultrasound touch sensor 100, which embodies various aspects of the technology described herein. The ultrasound touch sensor 100 may include a transducer array 302 that may include one or more transducer elements (not individually shown), a transmitter 304 (TX circuitry), a receiver 306 (RX circuitry), a sensor controller 308, a signal processor 310, and a memory device 320. In FIG. 3, the illustrated components are shown to be located on a single circuit board 312; however, in various other embodiments, one or more of the illustrated components may instead be located off-board. It should be appreciated that communication between one or more of the illustrated components may be performed in any of numerous ways, e.g., via one or more high-speed busses for high-speed intra-board communication and/or communication with one or more off-board components.

The transducer array 302 may take on any of numerous forms, and aspects of the present technology do not necessarily require the use of any particular type(s) or arrangement(s). As noted previously, the term “array” may include a single transducer element or multiple transducer elements. A transducer element of the array 302 may, for example, include a capacitive micromachined ultrasonic transducer (CMUT), a CMOS ultrasonic transducer (CUT), a piezoelectric micromachined ultrasonic transducer (PMUT), and/or another suitable ultrasonic transducer cell. The array 302, the transmitter 304, and the receiver 306 may be formed on separate chips. Alternatively, a combination of some or all of the array 302, the transmitter 304, and the receiver 306 may be part of an ultrasound-on-a-chip device in which components of the device are integrated on a single chip. Information regarding microfabricated ultrasonic transducers may be found in U.S. Pat. No. 9,067,779, assigned to the assignee of the present application, the entire contents of which is incorporated by reference herein. For example, the ultrasonic transducer may be a CUT, and electronic circuitry for processing signals and/or data from the CUT may be CMOS integrated circuitry formed on the same CMOS substrate as the CUT.

The sensor controller 308 may generate timing and control signals that are used to synchronize and coordinate operation of other components of the ultrasound touch sensor 100. For example, the sensor controller 308 may provide a pulse-control signal to the transmitter 304 to control generation and outputting of drive pulses by the transmitter 304 to the transducer array 302. The controller 308 may be driven by a clock signal CLK supplied to an input port 316 of the ultrasound touch sensor 100.

The drive pulses from the transmitter 304 may drive the transducer element(s) of the transducer array 302 individually or collectively. At least one transducer element of the array 302, in response to the drive pulses from the transmitter 304, may vibrate and output pigs or pulses of ultrasonic sound waves.

Reflected or echo sound waves, which are reflected from surfaces and interfaces of the smartphone 1, may impinge on the transducer element(s) of the array 302, causing the transducer element(s) to vibrate and output analog electrical signals representing vibration data. The receiver 306 may generate digital electrical signals from the vibration data obtained from the array 302, and may provide the digital electrical signals to the signal processor 310.

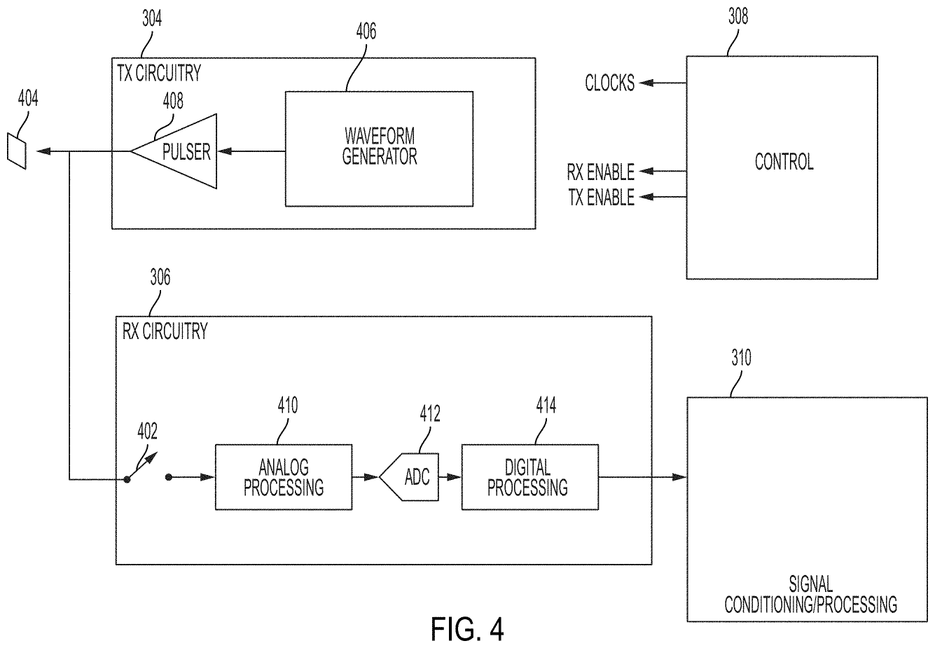

FIG. 4 is a block diagram illustrating, in some embodiments, how the transmitter 304 may be used with a given transducer element 404 to energize the transducer element 404 to emit a ping of ultrasonic sound waves, and how the receiver 306 may be used to obtain from the transducer element 404 an analog electrical signal, and to process the analog signal. The analog signal may correspond to vibration data representing reflected sound waves from the ping and sensed by the transducer element 404. In an embodiment, the transmitter 304 may operate during a transmission phase, and the receiver 306 may operate during a reception phase, which does not overlap with the transmission phase.

More specifically, as shown in FIG. 4, in addition to generating and outputting clock signals to drive components of the ultrasound touch sensor 100, the sensor controller 308 may selectively output a TX signal, to enable operation of the transmitter 304 during the transmission phase, or an RX signal to enable operation of the receiver 306 during the reception phase. The receiver 306 may include a switch 402, which may be in an opened state when the transmitter is enabled, so as to prevent an output from the transmitter 304 from driving the receiver 306. The switch 402 may be closed when the receiver 306 is enabled, so as to allow the receiver 306 to receive and process signals generated by the transducer element 404.

The transmitter 304 may include a waveform generator 406 and a pulser 408. The waveform generator 406 may, for example, be configured to generate a waveform that is to be applied to the pulser 408, to cause the pulser 408 to output to the transducer element 404 a driving signal corresponding to the generated waveform.

The receiver 306 may include an analog processor 410, an analog-to-digital converter (ADC) 412, and a digital processor 414, which function collectively to receive and process an analog signal and to output a digital signal to the signal processor 310.

The signal processor 310 may process the electrical signals from the receiver 306 to generate acoustic reflection or echo patterns. The acoustic reflection patterns may provide information on current surface conditions of the smartphone 1. For example, the smartphone 1 may give rise to:
one type of acoustic reflection pattern if the smartphone 1 is resting on a table,
another type of acoustic reflection pattern if the smartphone 1 is resting in a garment pocket,
yet another type of acoustic reflection pattern if the smartphone 1 is in a handbag,
various other types of acoustic reflection patterns if the smartphone 1 is being held in various hand positions, such as those shown in FIGS. 2A-2H.
   As will be appreciated, different types of contact with exterior surfaces of the smartphone 1 may give rise to different acoustic reflection patterns, because the different types of contact may cause different changes to surface characteristics of the smartphone 1.

Acoustic reflection patterns may be used to determine whether the smartphone 1 is being held or grasped in one of a plurality of typical hand positions of a user who intends to use one or more functions of the smartphone 1 (“phone-use position” herein), whether the smartphone 1 was touched incidentally (e.g., shifted positions in a garment pocket) but not intended to be used, whether the smartphone 1 has remained substantially unchanged relative to one or more previous acoustic reflection patterns, etc. The signal processor 310 may access a database of patterns stored in the memory device 320 and compare an acoustic reflection pattern, generated from reflected sound waves, to a pattern stored in the memory device 320. If the acoustic reflection pattern matches a stored pattern or is substantially similar to a stored pattern corresponding to a phone-use position, then the signal processor 310 may output a wake-up signal to a smartphone controller (not shown) external to the ultrasound touch sensor 100, via an output port 314, which may in turn activate various functions of the smartphone 1. For example, the smartphone controller may commence a user authentication procedure upon receipt of a wake-up signal from the signal processor 310.

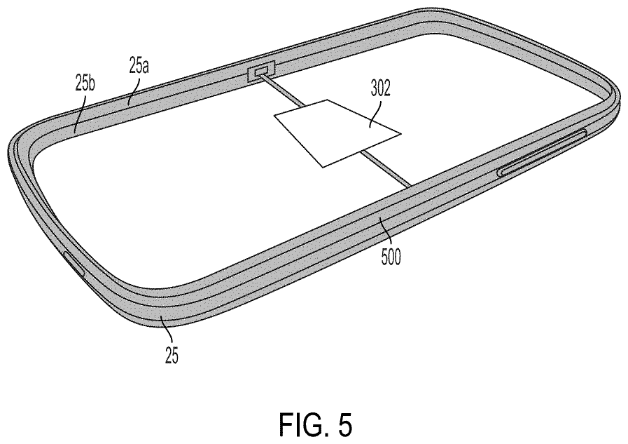

The upper cover 10, the display screen 5, the lower cover 20, and the edge portion 25 collectively may be considered a housing of the smartphone 1. Pulses of ultrasonic sound waves may be launched or emitted from the transducer array 302 into one or more portions of the housing. The pulses may be emitted directly into one or more materials forming the portion(s) of the housing or may be launched via a coupling medium connecting the transducer array 302 to the portion(s). For example, as schematically shown in FIG. 5, the transducer array 302 may be arranged in the housing and oriented to launch pulses of ultrasonic sound waves into the edge portion 25 of the housing. (For the sake of clarity, only the transducer array 302 of the ultrasound touch sensor 100 is shown in FIG. 5.) The edge portion 25 may be formed of a continuous band of material encircling a periphery of the smartphone 1. The edge portion 25 may have a first section 25a that extends from the upper cover 10 and a second section 25b that extends from the lower cover 20, such that when the smartphone 1 is assembled the edge portion 25 has an interface where the first section 25a meets the second section 25b. Alternatively, the edge portion 25 may be structured to extend predominantly from the upper cover 10 or from the lower cover 20.

The edge portion 25 may form part of a transmission path 500 for the ultrasonic sound waves, including reflected sound waves, as schematically depicted in gray in FIG. 5. That is, once a pulse of ultrasonic sound waves is launched into the edge portion 25 from the transducer array 302, the ultrasonic sound waves may travel in whole or in part within material forming the edge portion 25. When the ultrasonic sound waves encounter surfaces (e.g., an exterior surface touchable by a user, an interior surface, etc.) and interfaces (e.g., an interface between the first and second sections 25a, 25b of the edge portion 25, a manufacturing seam in the material forming the edge portion 25, etc.) at least some of the ultrasonic sound waves may be reflected back to the transducer array 302 via the transmission path 500.

Similarly, the upper cover 10 and/or the lower cover 20 may form the transmission path 500. As will be appreciated, the transmission path 500 may include any portion of the smartphone 1 that is formed of a material that is able to transmit ultrasonic sound waves and that is connected directly or indirectly to the transducer array 302 via one or more materials able to transmit ultrasonic sound waves.

When the smartphone 1 is resting on a flat surface (e.g., a table), the edge portion 25 may give rise to an acoustic reflection pattern that includes specific features corresponding to the surfaces and interfaces encountered by the pulse of ultrasonic sound waves. When the smartphone 1 is being held by a user, pressure and/or heat imparted by the user's hand(s) at one or more areas of the edge portion 25 may result in a different acoustic reflection pattern. As mentioned above, the signal processor 310 compares the acoustic reflection patterns with patterns stored in the memory device 320, and may issue a signal via the output 314 based on a comparison result.

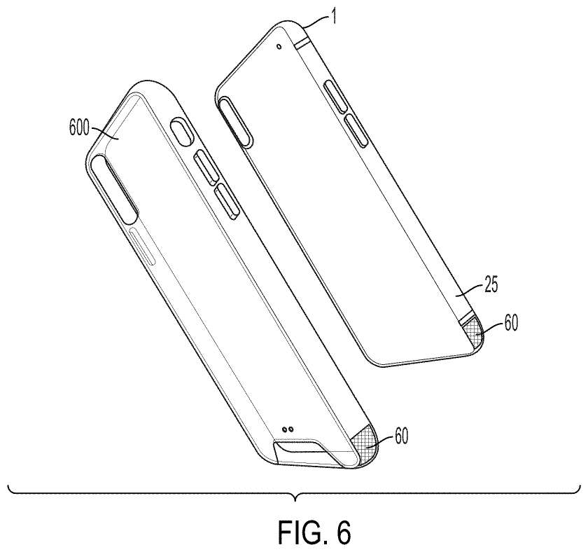

Optionally, the smartphone 1 may be used with a removable case or cover 600 as schematically shown in FIG. 6. The transmission path 500 may include a portion disposed on the exterior surface of the housing. For example, the transmission path 500 may include a portion disposed on the edge portion 25 of the housing. A coupling medium 60 may be used on the removable cover 600 and/or the smartphone 1 to couple the transmission path 500 of the smartphone 1 to the removable cover 600. The coupling medium 60 may enable the removable cover 600 to be part of the transmission path 500. Such an extension of the transmission path 500 may enable a touch on a surface of the removable cover 600 to be detected by the ultrasound touch sensor 100. The coupling medium 60 may be formed of a solid material. For example, the solid material may be an elastomer.

According to another aspect of the present technology, a method of detecting touch on an electronic device may include: emitting, from an ultrasound touch sensor disposed within a housing of the electronic device, a ping of ultrasonic sound waves; receiving by the ultrasound touch sensor, reflected ultrasonic sound waves reflected from a surface portion corresponding to a physical contact on an exterior surface of the housing; and comparing, by processing circuitry of the electronic device, data corresponding to the reflected ultrasonic sound waves to a stored reflection pattern. The method may further include activating a function of the electronic device when a match is determined between the data corresponding to the reflected ultrasonic sound waves and the stored reflection pattern.

According to another aspect of the present technology, a touch-detection method of a smartphone device is provided. The smartphone device may have a sleep mode and active mode, and may be structured to include: a housing having an interior and an exterior; a first array of ultrasonic transducers disposed in the interior of the housing; and processing circuitry disposed in the interior of the housing and configured to control the array of ultrasonic transducers to detect a touch on the exterior of the housing and to switch between the sleep mode and active mode in response to detecting the touch. The smartphone device also may include a memory device disposed in the interior of the housing. According to the method, the processing circuitry may perform steps to: control the first array to emit a first ping of an ultrasonic wave, process first reflection data output from the first array, the first reflection data corresponding to a first reflected wave resulting from the first ping, and activate the active mode, if the first reflection data is recognized to correspond to a wake-up touch based on data stored in the memory device.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

Any reference to a numerical value being between two endpoints, if such a reference is made herein, should be understood to encompass a situation in which the numerical value can assume either of the endpoints. For example, stating that a characteristic has a value between A and B, or between approximately A and B, should be understood to mean that the indicated range is inclusive of the endpoints A and B unless otherwise noted.

Also, the phraseology and terminology used herein is for the purpose of description and should not be regarded as limiting. The use of “including,” “comprising,” “having,” “containing,” and “involving,” as well as variations thereof herein, is meant to encompass the items listed thereafter and equivalents thereof as well as additional items.

Some aspects of the present technology may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

What is claimed is:

1. An electronic device with ultrasound touch detection, comprising:
a housing; and
an ultrasound touch sensor disposed within the housing and configured to detect physical contact with an exterior surface of the housing, wherein the ultrasound touch sensor comprises an ultrasound-on-a-chip device.

2. The electronic device of claim 1, wherein the ultrasound touch sensor is configured to emit ultrasonic sound waves, receive reflected ultrasonic sound waves reflected from a surface portion corresponding to the physical contact at the exterior surface of the housing, and compare data corresponding to the reflected ultrasonic sound waves to a stored reflection pattern.

3. A smartphone device comprising:
a housing;
an ultrasonic transducer device located within the housing and structured to transmit ultrasonic waves and to receive reflected waves of the ultrasonic waves, wherein the ultrasound transducer device comprises an ultrasound-on-a-chip device;
a memory device located within the housing; and
processing circuitry located within the housing and operatively connected to the ultrasonic transducer device and the memory device, wherein the processing circuitry is programmed to perform a touch-detection routine to:
control the ultrasonic transducer device to emit a ping ultrasonic wave,
process reflection data obtained from the ultrasonic transducer device, the reflection data corresponding to at least one reflected wave resulting from the ping ultrasonic wave, and
activate a predetermined smartphone function if the reflection data is recognized to correspond to a pattern stored in the memory device.

4. The smartphone device according to claim 3, wherein the predetermined smartphone function is one of:
a user control function,
an application functionality function, and
an operating system function.

5. The smartphone device according to claim 3, wherein
the ultrasonic transducer device includes first and second ultrasonic transducers,
the ping ultrasonic wave includes first and second ping waves emitted from the first and second ultrasonic transducers, and
the reflection data corresponds to a first reflected wave resulting from the first ping wave and a second reflected wave resulting from the second ping wave.

6. A smartphone device having a sleep mode and active mode, the smartphone device comprising:
a housing having an interior and an exterior;
a first array of ultrasonic transducers disposed in the interior of the housing; and
processing circuitry disposed in the interior of the housing and configured to control the first array of ultrasonic transducers to detect a touch on the exterior of the housing and to switch between the sleep mode and active mode in response to detecting the touch.

7. The smartphone device according to claim 6, wherein
the smartphone device further comprises a memory device disposed in the interior of the housing,
the interior of the housing is delimited by first and second cover portions and an edge portion, each of the first and second cover portions being substantially planar and having an outer periphery, the edge portion separating the first portion from the second portion, and the edge portion being positioned adjacent the outer peripheries of the first and second portions,
the processing circuitry is operatively connected to the memory device, and
the processing circuitry is programmed to, when the smartphone device is in the sleep mode, perform a touch-detection routine to:
control the first array to emit a first ping of an ultrasonic wave,
process first reflection data output from the first array, the first reflection data corresponding to a first reflected wave resulting from the first ping, and
activate the active mode, if the first reflection data is recognized to correspond to a wake-up touch based on data stored in the memory device.

8. The smartphone device according to claim 7, wherein the touch-detection routine of the processing circuitry analyzes the first reflection data to determine whether an acoustic impedance of the first reflected wave has changed from a previous reflected wave, and determines that the first reflection data indicates a wake-up touch when a change in the acoustic impedance of the first reflected wave is above a predetermined value.

9. The smartphone device according to claim 7, wherein the housing includes a sound-wave transmission path operatively connected to the first array.

10. The smartphone device according to claim 9, wherein the sound-wave transmission path includes an external portion structured to couple with a sound-wave transmission path of a removable case applied to the housing.

11. The smartphone device according to claim 9, wherein:
the touch-detection routine of the processing circuitry analyzes the first reflection data to determine whether an acoustic impedance of the first reflected wave has changed, and determines that a first anomaly has occurred in the first reflected wave when a change in the acoustic impedance of the first reflected wave is above a first predetermined value, and,
when the first anomaly is determined to have occurred in the first reflected wave, the touch-detection routine of the processing circuitry determines a first touch location on the sound-wave transmission path based on a time delay between emission of the first ping and receipt of the first reflected wave corresponding to the first anomaly.

12. The smartphone device according to claim 11, further comprising a second array of ultrasonic transducers located within the housing, each of the ultrasonic transducers of the second array being structured to transmit second ultrasonic waves and to receive second reflected waves of the second ultrasonic waves wherein the second array is operatively connected to the sound-wave transmission path, wherein the touch-detection routine of the processing circuitry:
controls the second array to emit a second ping of an ultrasonic wave, the second ping being different from the first ping emitted by the first array, and
processes second reflection data received by the second array, the second reflection data corresponding to a second reflected wave resulting from the second ping.

13. The smartphone device according to claim 12, wherein
the touch-detection routine of the processing circuitry analyzes the second reflection data to determine whether an acoustic impedance of the second reflected wave has changed, and determines that a second anomaly has occurred in the second reflected wave when a change in the acoustic impedance of the second reflected wave is above a second predetermined value, and,
when an occurrence of a second anomaly is determined to have occurred in the second reflected wave, the touch-detection routine of the processing circuitry determines a second touch location on the sound-wave transmission path based on a time delay between emission of the second ping and receipt of the second reflected wave corresponding to the second anomaly.

14. The smartphone device according to claim 13, wherein the touch-detection routine of the processing circuitry:
determines a single touch location for the wake-up touch when the first touch location corresponds to the second touch location, and
determines multiple touch locations for the wake-up touch when the first touch location is different from the second touch location.

15. The smartphone device according to claim 6, wherein the processing circuitry is programmed to, when the smartphone device is in the active mode, perform a training routine to:
enable touch data to be inputted actively or passively by a user, and
store the touch data as a pattern in the memory device.

16. The smartphone device according to claim 15, wherein the touch data corresponds to a holding position and is inputted by the user by grasping the smartphone in a preferred position.

17. The smartphone device according to claim 6, wherein the processing circuitry is programmed to, when the smartphone device is in the active mode, perform a second touch-detection routine to:
control the ultrasonic transmitter to emit a second ping ultrasonic wave,
process second reflection data obtained from the ultrasonic receiver, the reflection data corresponding to at least one wave reflected from the second ping ultrasonic wave,
compare the second reflection data with the patterns stored in the memory device, and activate one of:
a user control function,
an application functionality function, and
an operating system function.

18. The smartphone device according to claim 17, wherein the user control function controls any one or a combination of:
speaker volume adjustment,
microphone volume adjustment,
screen brightness adjustment,
camera operation,
flashlight operation,
wifi connectivity, and
Bluetooth connectivity.

19. The smartphone device according to claim 17, wherein the application functionality function controls any one or a combination of:
cursor movement,
copy and paste operations,
a page refresh operation, and
a Web search operation.

20. The smartphone device according to claim 17, wherein the operating system function controls any one or a combination of:
application launch and exit operations,
an application accessibility selection,
software update operations,
smartphone on and smartphone off operations, and
user authentication operations.
